(19) United States
(12) Patent Application Publication
(10) Pub. No.: US 2009/0009139 A1
(43) Pub. Date: Jan. 8, 2009

(54) ACCUMULATOR WITH AN ADAPTABLE CHARGE SHUTOFF VOLTAGE

(76) Inventor: Jochen BERTSCH, Muehlacker-Grossglattbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/166,371

(22) Filed: Jul. 2, 2008

(30) Foreign Application Priority Data
Jul. 6, 2007 (DE) 10 2007 031 563.7

(51) Int. Cl. H02J 7/00

(52) U.S. Cl. 320/137

(57) ABSTRACT

An accumulator with a rechargeable battery for operating an electrical device, in particular an electrical power tool, has an electronic voltage circuit. The voltage circuit has at least one electronic component, in particular a diode, which generates a defined voltage drop. The charge shutoff voltage is thus adjusted.

### CROSS-REFERENCE TO RELATED APPLICATIONS

This application is based on German Patent Application No. 10 2007 031 563.7 filed on Jul. 6, 2007, upon which priority is claimed.

### BACKGROUND OF THE INVENTION

1. Field of the Invention

The invention relates to an accumulator for an electrical device, in particular an electrical power tool, having a rechargeable battery and terminals for a charger.

2. Background of the Invention

Electrical devices whose operation independently of mains sources is necessary or desired at least from time to time are equipped with an accumulator that has rechargeable batteries. Different types and sizes for many applications are currently available. Typical types for such rechargeable batteries, in accordance with the components contained in each of them, are for example lead-acid, nickel-cadmium (NiCd), nickel-metal hydride (NiMH), lithium-ion (LiIo), or lithium-polymer batteries. These can be used repeatedly and recharged in a suitable charger. Rechargeable batteries are known for instance from German Patent DE 33 47 717 C2.

Chargers for charging rechargeable batteries are known in manifold versions in the prior art. In them, charge operation systems are also used, with the aid of which various physical variables of the battery to be charged are taken into account. For instance, in German Patent Disclosure DE 10 2005 020 356 A1, a charger is disclosed which has at least one battery parameter. The charger includes a computation unit, which makes it possible to design the charging operation to suit the aging states individually present in the rechargeable batteries.

In charging, only some of the electrical energy available is converted into a charge. Another portion of it is converted into heat at the internal resistor of the rechargeable battery and is thus lost to the charging operation. This lost power can lead to unwanted heating of the rechargeable battery and thus of the accumulator. The charging operation must therefore be monitored. Especially lithium-based battery cells, or battery packs, are charged to a certain voltage, which must also be monitored and regulated by the charger. When the charge termination voltage specified in the accumulator is reached, the charging operation is terminated or the charging current is limited in such a way that the voltage of the lithium-based cells can be kept constant.

### OBJECT AND SUMMARY OF THE INVENTION

In the context of the present application, the term accumulator is understood to mean a rechargeable battery, which besides the rechargeable battery or rechargeable battery pack itself has at least one further component, such as an electronic circuit, terminals for an electrical machine, or a locking mechanism for connection to an electrical device, in particular an electrical power tool.

To enable setting a defined charge termination voltage, it is proposed according to the invention that an electronic voltage circuit be provided between the accumulator and the charger, and this circuit has components with which a defined voltage drop can be attained. To that end, the accumulator is provided with an electronic voltage circuit that is equipped with at least one electronic component which generates a defined voltage drop. It can thus be attained that the shutoff voltage, regardless of the charger used, even for future accumulators not yet defined, is adjustable directly at the accumulator itself. Thus the known chargers can continue to be used for future lithium-based accumulators, and a flexible charging process for lithium-based battery packs that is guaranteed to be usable in the future can be furnished.

It is especially advantageous to construct the voltage circuit with diodes as its components. This is because diodes on the one hand have a defined voltage drop per diode. On the other, different types of diodes are known, which also each have a different voltage drop. Hence diodes are available that have a voltage drop of between 0.1 and 1 Volt, aid typically between 0.2 and 0.7 volts, such as 0.6 volts.

In the voltage circuit, the requisite number of diodes is preferably connected in series; the type and the number of the diodes are selected such that all in all, the desired voltage drop is attained. Thus in one series circuit, different diodes can be used.

In such a series circuit, diodes of the same type, each with the same voltage drop, can also be used, for instance with a voltage drop of 0.6 volts each.

Typically, the lithium-based rechargeable battery includes a plurality of battery cells, which are interconnected in such a way that the desired voltage results. In a further embodiment of the invention, the number of diodes in the voltage circuit is therefore selected such that it is equal to the number of battery cells in the rechargeable battery.

In an alternative embodiment, different types of diodes, at least some of which also having a different voltage drop, can also be used. This makes it possible for the charge termination voltage required for each battery pack can be set precisely.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 schematically shows an accumulator with a voltage circuit located between the accumulator and the charger according to a first embodiment of the invention;

FIG. 2 schematically shows an accumulator with a voltage circuit located between the accumulator and the charger according to a second embodiment; and

FIG. 3 schematically shows an accumulator with a voltage circuit located between the accumulator and the charger according to a third embodiment.

### DESCRIPTION OF THE PREFERRED EMBODIMENTS

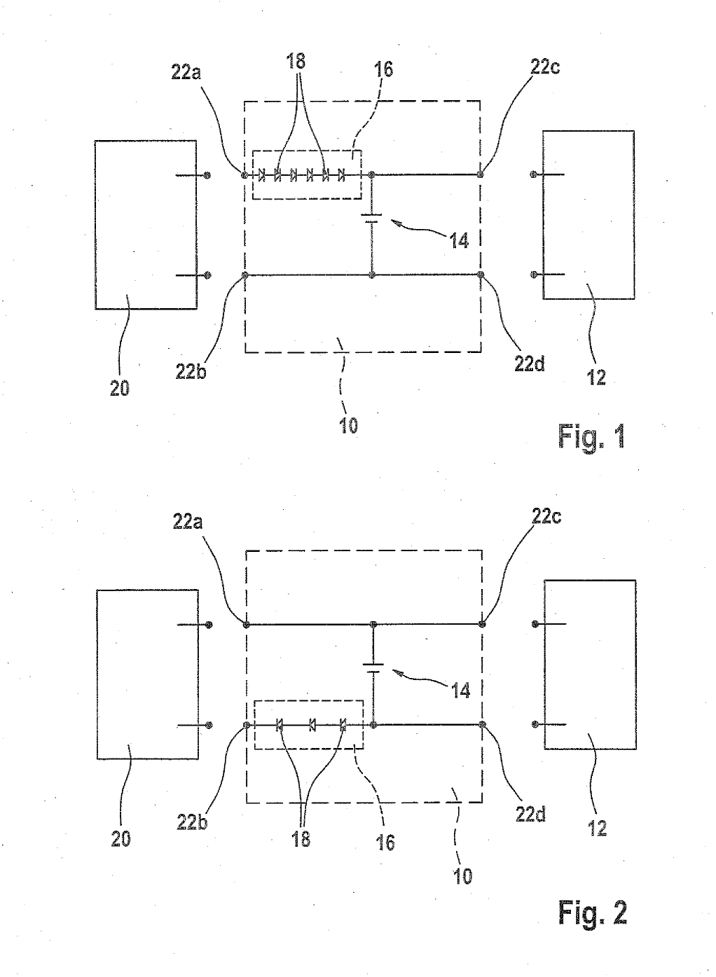

FIG. 1 schematically shows an accumulator 10, which via terminals 22a through 22d can be connected on the one hand to an electrical device 12, such as an electrical power tool, and on the other to a charger 20. The accumulator 10 has a rechargeable battery 14, which is preferably constructed as a lithium-based battery with a number of battery cells. The construction of lithium-based batteries is known per se and will therefore not be described further here.

The accumulator 10 also has a voltage circuit 16, with which a particular desired voltage drop can be set in the accumulator. To that end, at least one electronic component 18 is provided in the voltage circuit 16. In the example show in FIG. 1, six diodes are used as electronic components 18, and with them the voltage can be lowered in a defined way in each case. The voltage circuit 16 is provided in the positive branch.

The charger 20 furnishes a defined output voltage, for instance of 20 volts. In this example, it is assumed that the rechargeable battery 14 is to be charged to as high as 16.4 volts. To that end, with the aid of the voltage circuit 16, the desired shutoff voltage of the rechargeable battery 14, and thus of the accumulator 10, is set. If diodes which have a voltage drop of 0.6 volts per diode are used in the voltage circuit 16, then the entire voltage drop can be set to 3.6 volts by means of a series circuit of six diodes. Accordingly, six diodes are connected in series in the voltage circuit.

As shown in FIG. 2, it is also possible to provide the voltage circuit 16 in the negative branch. For example, three electronic components 18, which are embodied as diodes, can be provided in the negative branch for that purpose.

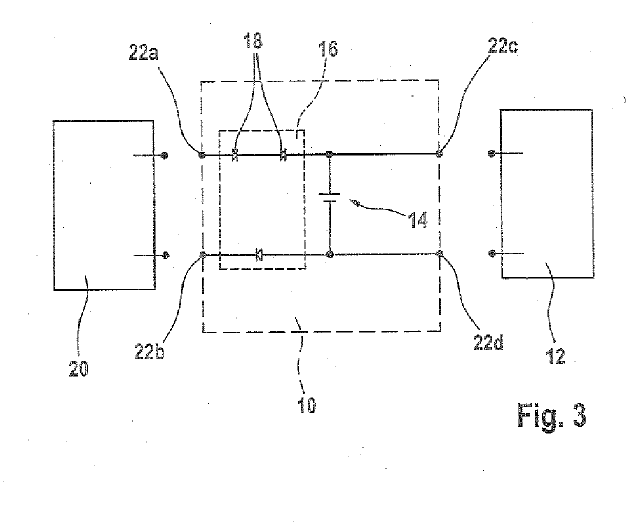

In FIG. 3, a further example for the possibility of realizing the voltage circuit 16 is shown. For this purpose, the electronic components 18, which assure a defined voltage drop and which in this example are embodied as diodes, are disposed both in the positive branch and in the negative branch. For instance, two diodes may be provided in the positive branch and one diode in the negative branch.

In principle, however, the number of diodes used depends on their type and thus on their respective voltage drop, which in diodes is typically between 0.2 and 0.7 volts.

It is especially advantageous to adapt the number of diodes used to the number of battery cells used in the rechargeable battery. Thus the number of diodes can be selected to equal the number of battery cells. The prerequisite, however, is that the charging voltage of the charger 20 be higher than the maximum voltage of the rechargeable battery.

The voltage circuit has been described here in terms of series-connected diodes. However, still other voltage circuits may also be used, with which a defined voltage drop can be set. These include in particular adjustable voltage regulators or step-down converters, with which a defined voltage drop can likewise be generated in the context of a circuit arrangement.

The accumulator of the invention furthermore has the advantage that even mixing different battery cells, which have a different shutoff voltage, is made possible. For instance, if a certain battery cell is not sufficiently available, a shift can be made to a different type of battery cell; the shutoff voltage merely has to be adjusted using the electronic voltage circuit 16. Thus the accumulator 10 is composed of battery cells of different types and a suitable voltage circuit 16, yet externally cannot be distinguished from the accumulator used until now for the same application. This assures high availability of accumulators and hence great flexibility.

The foregoing relates to preferred exemplary embodiments of the invention, it being understood that other variants and embodiments thereof are possible within the spirit and scope of the invention, the latter being defined by the appended claims.

We claim:

1. An accumulator for an electrical device, in particular an electrical power tool, the accumulator comprising:
a rechargeable battery;
terminals connected to the battery for connecting to a charger; and
an electronic voltage circuit which generates a defined voltage drop, wherein the electronic voltage circuit has at least one electronic component.

2. The accumulator as defined by claim 1, wherein the electronic component is embodied as a diode.

3. The accumulator as defined by claim 2, wherein the electronic voltage circuit has one or more diodes connected in series.

4. The accumulator as defined by claim 2, wherein a voltage drop at each diode is between 0.1 and 1 volts, and in particular between 0.2 and 0.7 volts.

5. The accumulator as defined by claim 3, wherein a voltage drop at each diode is between 0.1 and 1 volts, and in particular between 0.2 and 0.7 volts.

6. The accumulator as defined by claim 3, wherein a voltage drop is the same at each diode.

7. The accumulator as defined by claim 4, wherein a voltage drop is the same at each diode.

8. The accumulator as defined by claim 5, wherein a voltage drop is the same at each diode.

9. The accumulator as defined by claim 3, wherein a voltage drop is different at least two diodes.

10. The accumulator as defined by claim 4, wherein a voltage drop is different at least two diodes.

11. The accumulator as defined by claim 5, wherein a voltage drop is different at least two diodes.

12. The accumulator as defined by claim 2, wherein a number of diodes is equal to a number of battery cells of the rechargeable battery.

13. The accumulator as defined by claim 3, wherein a number of diodes is equal to a number of battery cells of the rechargeable battery.

14. The accumulator as defined by claim 4, wherein a number of diodes is equal to a number of battery cells of the rechargeable battery.

15. The accumulator as defined by claim 5, wherein a number of diodes is equal to a number of battery cells of the rechargeable battery.

16. The accumulator as defined by claim 6, wherein a number of diodes is equal to a number of battery cells of the rechargeable battery.

17. The accumulator as defined by claim 9, wherein a number of diodes is equal to a number of battery cells of the rechargeable battery.
